(19) United States
(12) Patent Application Publication
(10) Pub. No.: US 2006/0139452 A1
(43) Pub. Date: Jun. 29, 2006

(54) System for processing visual information and method of visual surveillance

(75) Inventor: Wilhelmus Petrus Arnoldus Van Deijzen, Waalwijk (NL)

Correspondence Address: THE WEBB LAW FIRM, P.C., 700 KOPPERS BUILDING, 436 SEVENTH AVENUE, PITTSBURGH, PA, 15219, US

(73) Assignee: VSC International B.V., Waalwijk (NL)

(21) Appl. No.: 10/536,553

(22) PCT Filed: Nov. 28, 2003
(86) PCT No.: PCT/NL03/00839

§ 371 Date: Feb. 10, 2006

(30) Foreign Application Priority Data
Nov. 29, 2002 (NL) 1022036

(51) Int. Cl. H04N 7/18; H04N 9/47

(52) U.S. Cl. 348/143

(57) ABSTRACT

The invention relates to a system for processing visual information, comprising: a number of cameras for recording visual information, a control room in communication with the cameras and having means for displaying recorded visual information, and control means for influencing the information displayed in the control room. The invention also relates to a method for visual surveillance.

The invention relates to a system for processing visual information, comprising: a number of cameras for recording visual information, a control room in communication with the cameras and having means for displaying recorded visual information, and control means for influencing the information displayed in the control room. The invention also relates to a method of visual surveillance.

The application of cameras for recording visual information is generally known. The use of camera surveillance has expanded enormously in recent times in order to allay a sense of insecurity and to increase safety. Use is generally made for this purpose of a number of different cameras, the images from which are transmitted to a central communications room. In the communications room the operator (security guard) normally views some of the provided images. Such systems are applied in city centres, industrial estates, stadiums and so on. The investment for setting up and keeping said camera systems operational is very considerable. It is necessary to take into consideration here infrastructural investment (cameras, connections, processing equipment) and staff (salary costs, training courses). The improvements in existing systems are sought in the prior art mainly in the improvement in the infrastructural means. However, applicant has had as insight that a very significant limitation of the existing systems is rather to be found in the “human factor”.

The invention therefore has for its object to provide an improved system for processing visual information and to a method of visual monitoring with which particularly the behaviour of an operator of a surveillance system can be improved.

The invention provides for this purpose a system for processing visual information, comprising: a number of cameras for recording visual information, a control room in communication with the cameras and having means for displaying recorded visual information, and control means for influencing the information displayed in the control room, characterized in that the system is also provided with storage means for storing the operations performed with the control means. The storage means are preferably also adapted to store the operations performed with the control means in combination with at least a part of the visual information displayed as a result of the operations performed with the control means. With such a system the behaviour of an operator also falls within the system limits. The behaviour of the operator hereby becomes measurable and thus more controllable. Now that the behaviour of the operator can also be measured and evaluated, there is the possibility of tracing, and then influencing, less favourable behaviour of operators. Owing to the possibility of monitoring the behaviour of an operator, incorrect behaviour of an operator can also be dealt with specifically. It is expected that providing the possibility of supervision of the behaviour of an operator will already have a favourable effect on behaviour. Linked storage of the displayed visual information and storage of the performed operations provides an easier coupling of operations and the images displayed as a consequence thereof. Also from a legal point of view this has the advantage that the behaviour of an operator can thus be analysed more easily. In particular circumstances it is customary that all observed visual information is stored (for instance on hard disks or tapes). The access to such records (partly because of privacy laws and the enormous quantity of records) is however often impossible or at least extremely time-consuming. This problem does not exist in the system according to the present invention.

In an advantageous embodiment variant of the system, the control room is also provided with communication means and the storage means are adapted to store the operations performed with the communication means. The communication behaviour of an operator (for instance an emergency switch, a telephone line and so on) is thus also brought within the controllable system limits. The communication behaviour of operators can hereby also be evaluated and, in general, improved.

In order to link the identity of an operator in simple manner to the stored operations performed with the control means, it is recommended that the system is also provided with input means for supplying to the storage means an identification of the operator of the control means.

For a simple further processing of the information supplied to the storage means, it is advantageous if the system is also provided with a data processing unit with which statistical information is generated from the operations performed with the control means. Such statistical information can thus be generated in real time, so that a rapid feedback is also possible. The feedback can be automated when the data processing unit connects to a control module with which the information displayed in the control room is controlled. It is possible here to envisage activation (display of an image recorded with a specific camera) if this image has not been displayed for a longer period, or expressly displaying, on the basis of historical information, a camera image which has previously prompted a particular intervention (such as displaying the image of a street in an entertainment district on Saturday evening around closing time because this has resulted in police assistance of a determined high priority being called in a number of times earlier in the month). Another possibility is to cause an alarm signal to go off (for instance a light signal and/or an acoustic signal) in the control room when an operator has not performed any operations for a determined period. The system is preferably also provided with second storage means adapted to store the statistical information generated by means of the data processing unit. This information can also be recorded therewith. A further development of the system even makes it possible to monitor the behaviour of an operator of the system by means of detection means arranged for this purpose in the control room.

The invention also provides a method of visual surveillance, comprising the steps of: A) recording visual information by means of a number of cameras, B) feeding the recorded information to a control room, C) selecting by an operator for observation purposes of a part of the available information from the recorded information fed to the control room, D) storing the information selected by the operator. In a preferred application of the method, the information selected by the operator as according to processing step (D) is stored in relation to the selection behaviour applied for this purpose by the operator. From the selection behaviour can then be generated statistical information which can be used to actively influence the operator. Such a method provides the advantages as already described above with reference to the device according to the present invention.

The control room for processing information recorded by the system can also be supplied with personal identification data. Such personal identification data can be generated by linking visual information to another information source. Such a source can for instance be a file which comes from an investigative department (linking outward appearance to an identification). Conversely, it is also possible to generate this information with the system. A stadium for instance can thus be provided with a camera which is disposed close to an entrance to the stadium and which is connected to the control room, in addition to a read device which is disposed close to an entrance to the stadium for reading a personal identification and which is connected to the control room. This provision increases the possibilities in respect of identifying people in the stadium. The linking of data can thus be made use of later when it is desired to obtain further information relating to the identity of a person observed in the complex by the camera device. It thus becomes possible to maintain order with greater efficiency (and to take preventive measures for future events) in a complex where large numbers of people are present. It is noted in respect of all (statistical) information generated by the system that this information is also highly suitable for supporting policy-related decision-making processes.

The present invention will be further elucidated on the basis of the non-limitative embodiments shown in the following figures; wherein:

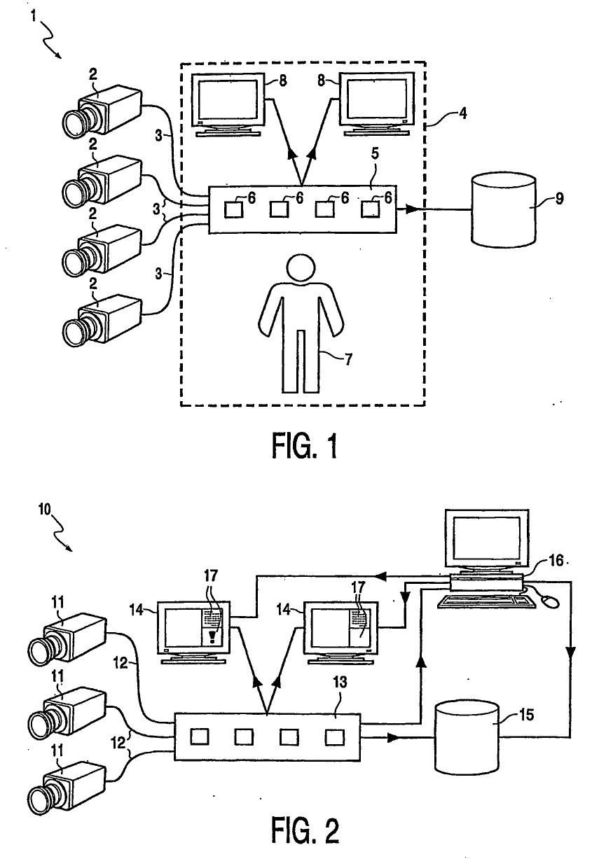

FIG. 1 shows a schematic view of a surveillance system according to the present invention,

FIG. 2 shows a schematic view of an alternative embodiment variant of a surveillance system according to the present invention, and

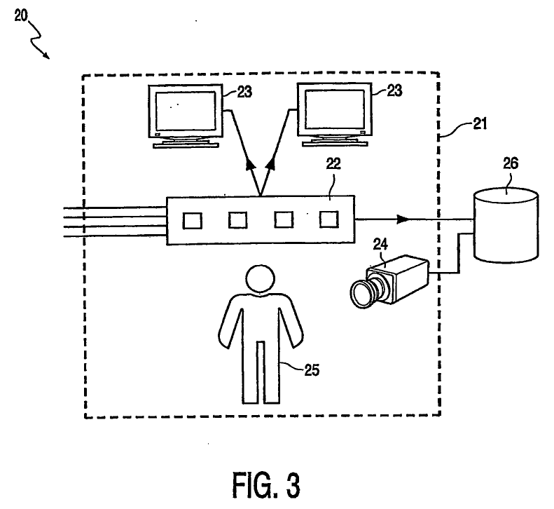

FIG. 3 is a schematic view of a part of a second alternative embodiment variant of a surveillance system according to the present invention.

FIG. 1 shows a surveillance system 1 provided with a number of cameras 2 which lead with cables 3 to a control room 4. In control room 4 the cables 3 connect to control means 5, provided schematically here with buttons 6. An observer 7 (also referred to as an operator) can determine by means of buttons 6 from which cameras 2 the images are displayed on observation monitors 8. The observation behaviour of observer 7 determines in significant part the quality of the surveillance services. This behaviour is stored in a database 9 in addition to the data relating to which buttons 6 have been operated at which moment and in which way by observer 7, and it is advantageous if the images displayed on monitors 8 as a result of these operations are also stored in database 9.

FIG. 2 shows an alternative embodiment variant of a surveillance system 10 with a number of cameras 11 which are connected with cables 12 to a control panel 13. Depending on the choices made during use of control panel 13, images from several of the cameras 11 are shown on monitors 14 in selected manner (for instance zoomed-in to a greater or lesser extent). The information relating to the displayed images is also transmitted to a database 15 where it is stored. Another information flow relating to the selected images goes to a computer 16. Computer 16 processes the information flow in respect of the selected images into statistical information which is then displayed (for instance in real time) in a window 17 on monitors 14. The statistical information coming from computer 16 is also fed to database 15 for storage thereof. It is noted that the information flows as shown relate only to a randomly chosen variant There are numerous ways of routing the information flows which are likewise possible.

Finally, FIG. 3 shows a part of a second embodiment variant of a surveillance system 20 in which, in addition to a control panel 22 and monitors 23, a camera 24 is also disposed in a control room 22 with which an operator 25 is observed. The information coming from camera 24 is fed for storage thereof to a database 26 in which are also stored the data relating to use of control panel 22 and the images selected as a result thereof.

1-15. (canceled)

16. A system for processing visual information, comprising:
a plurality of cameras for recording visual information,
a control room in communication with the cameras and having means for displaying recorded visual information, and
control means for influencing the information display in the control room, wherein the system is also provided with storage means for storing the operations performed with the control means.

17. The system as claimed in claim 16, wherein the storage means are adapted to store the operations performed with the control means in combination with at least a part of the visual information displayed as a result of the operations performed with the control means.

18. The system as claimed in claim 16, wherein the control room is also provided with communication means and the storage means are adapted to store the operations performed with the communication means.

19. The system as claimed in claim 16, wherein the system is also provided with input means for supplying to the storage means an identification of an operator of the control means.

20. The system as claimed in claim 16, wherein the system is also provided with a data processing unit with which statistical information is generated from the operations performed with the control means.

21. The system as claimed in claim 20, wherein the system is also provided with second storage means adapted to store the statistical information generated by means of the data processing unit.

22. The system as claimed in claim 20, wherein the data processing unit connects to a control module with which the information displayed in the control room is transmitted.

23. The system as claimed in claim 16, wherein the system is also provided with detection means for observing behaviour of an operator of the system.

24. The system as claimed in claim 23, wherein the detection means connect to the storage means for storing the operations performed with the control means, which storage means are also adapted to store the information generated with the detection means.

25. A method of visual surveillance, comprising the steps of:
A) recording visual information by means of a plurality of cameras,
B) feeding the recorded information to a control room,
C) selecting by an operator for observation purposes of a part of the available information from the recorded information fed to the control room, and
D) storing the information selected by the operator.

26. The method as claimed in claim 25, wherein the information selected by the operator as according to processing step (D) is stored in relation to the selection behaviour applied for this purpose by the operator.

27. The method as claimed in claim 25, wherein statistical information is generated from the selection behaviour.

28. The method as claimed in claim 27, wherein the statistical information is used to actively influence the operator.

29. The method as claimed in claim 25, wherein the control room for processing information recorded by the system can also be supplied with personal identification data.

30. The method as claimed in claim 29, wherein the personal identification data are generated by linking visual information to another information source.
